(19) United States
(12) Patent Application Publication
(10) Pub. No.: US 2004/0013829 A1
(43) Pub. Date: Jan. 22, 2004

(54) Preform for a blow molded plastic container

(76) Inventors: Stephen William Bushby, Northumberland (GB); Keith Stephenson, Newcastle Upon Tyne (GB)

Correspondence Address: LARSON & TAYLOR, PLC, 1199 NORTH FAIRFAX STREET, SUITE 900, ALEXANDRIA, VA, 22314, US

(21) Appl. No.: 10/432,012

(22) PCT Filed: Nov. 21, 2001
(86) PCT No.: PCT/GB01/05141

(30) Foreign Application Priority Data
Nov. 22, 2000 (GB) 0028504.9

(51) Int. Cl. B32B 1/08

(52) U.S. Cl. 428/34.1; 264/531; 264/529; 428/542.8

(57) ABSTRACT

A preform (20) for a plastics container (2) having a substantially rectangular body portion with a substantially rectangular neck (4) thereto, the preform (20) being characterised by four upstanding sidewalls defining a substantially rectangular neck portion (24) thereto, and a base portion (22) of substantially rectangular transverse sections, the base portion (22) comprising four sections (26, 28, 30, 32) each extending from the lower end of an associated sidewall and tapering in both width and thickness toward the centre of the base portion (22), one section (26, 28, 30, 32) to form each wall (6, 8, 10, 12) of the container (2), the base portion (22) further comprising a central section (34) into which the tapering sections (26, 28, 30, 32) merge, said central section to form part at least of base of the resilient container (2).

### FIELD OF THE INVENTION

This invention relates to containers, and more particularly to preforms for producing plastic containers with rectangular necks.

### TECHNICAL BACKGROUND

It is known to provide rectangular containers for containing and displaying the contents thereof, typically sweets, which containers may include lids for covering the rectangular necks of the containers.

Conventionally, such containers are injection moulded from polypropylene, such a process producing what are termed ‘contact clear’ containers—i.e. the containers are translucent but not transparent. Consequently the contents cannot be clearly seen.

### SUMMARY OF THE INVENTION

There is a need for rectangular necked containers the material of which is transparent, whereby the contents thereof can be more readily viewed.

According to a first aspect of the present invention there is provided a preform for a plastic container having a substantially rectangular body portion with a substantially rectangular neck thereto, the preform being characterised by four upstanding sidewalls defining a substantially rectangular neck portion thereto, and base portion of substantially rectangular transverse section, the base portion comprising four sections each extending from the lower end of an associated sidewall and tapering in both width and thickness toward the centre of the base portion, one section to form each wall of the container, the base portion further comprising, a central section into which the tapering sections merge, said central section to form part at least of the base of the resultant container.

In one embodiment of the invention, the base portion is substantially planar, while the central section of the base portion may be substantially rectangular, and, on stretch/blow moulding of the preform, may comprise the base of the resultant container.

In an alternative embodiment of the invention, the base portion is of generally truncated pyramidical shape, the central section of the base portion being substantially circular, and, on stretch/blow moulding of the preform, comprises the central regions of the base of the resultant container.

Preferably the material of the preform is polyethylene terephthalate (PET), the use of such material resulting in a strong and transparent product such that the contents thereof can be clearly seen.

However, other materials, such as polypropylene may also be used.

Conveniently the preform is injection moulded from PET.

A container according to the invention is formed by stretch/blow moulding a preform as defined above, the container comprising a substantially rectangular neck defined by the neck portion of the preform, four walls each defined by one of the tapered sections of the preform, and a base including the central section of the preform.

A method of manufacturing a plastic container comprises the steps of moulding a preform as defined above, and stretch/blow moulding the preform into a substantially rectangular container.

A machine for manufacturing a plastics container comprises a first station for forming a preform as defined above, a second station for conditioning the preforms, a third station for blowing and stretching the preforms into a substantially rectangular container, and a fourth station from which the containers are ejected.

### BRIEF DESCRIPTION OF THE DRAWINGS

FIG. 1 is a perspective view of a rectangular container formed from a preform according to the invention;

FIG. 2 is a plan view of a first preform according to the invention;

FIG. 3 is a section on the line III-III of FIG. 2:

FIG. 4 is a plan view of a second preform according to the invention;

FIG. 5 is a section on line IV-IV of FIG. 4, and

FIG. 6 is a plan view from above of a machine for manufacturing a container from a preform according to the invention.

### DESCRIPTION OF THE PREFERRED EMBODIMENTS

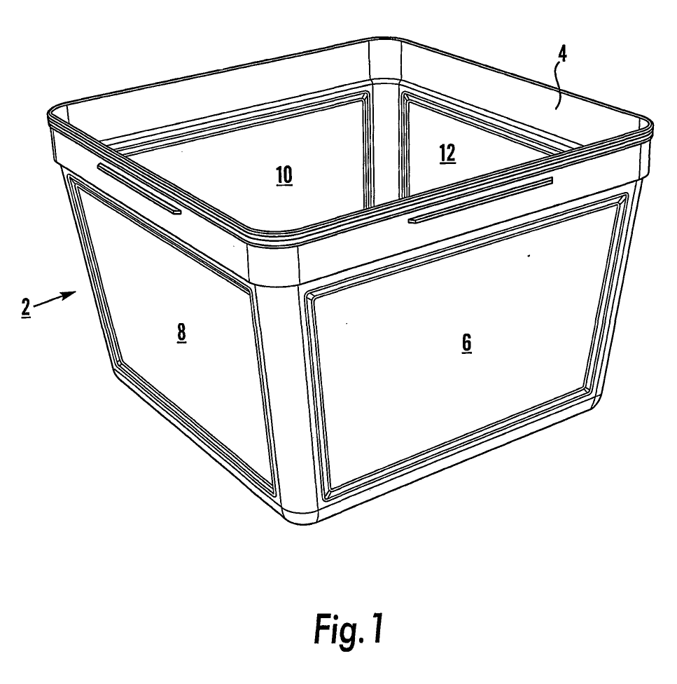

Referring to FIG. 1 there is shown a square container indicated generally at 2 which has been stretch/blow moulded from PET, the container including a square neck 4 from which depend four walls 6,8,10,12 and a transverse base (not shown). The container, being of stretch/blow moulded PET, is transparent and strong, being capable of withstanding substantial forces without breaking or cracking.

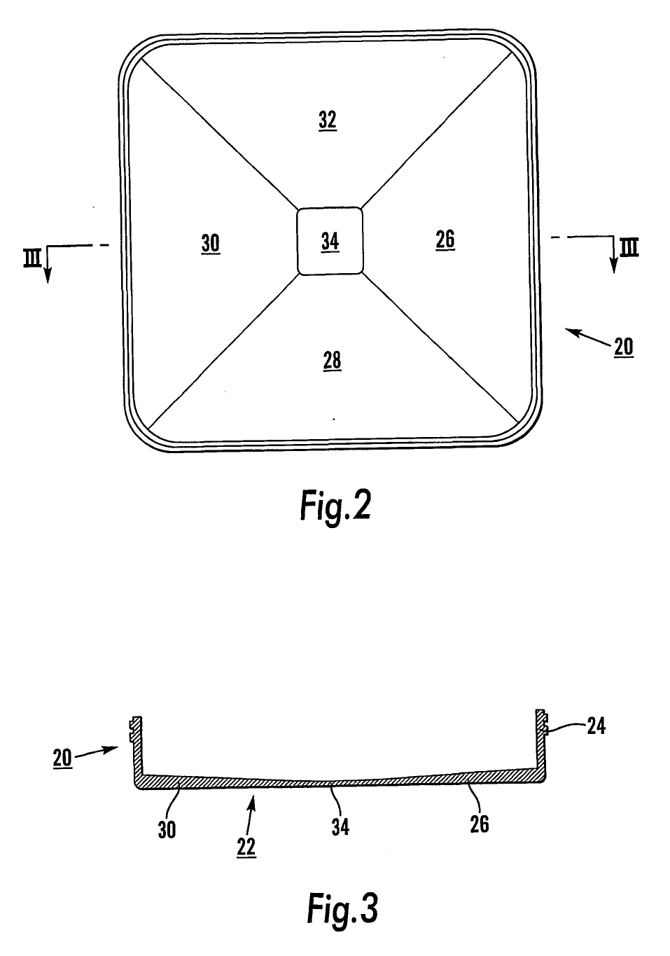

Referring to FIGS. 2 and 3, there is shown a preform, indicated generally at 20, from which the container 2 of FIG. 1 has been shaped.

More particularly, the preform 20, which is injection moulded from PET, is of a generally rectangular shape in transverse section, and includes a square base portion indicated generally at 22 from which upstands a square neck portion 24.

The base portion 22, which is substantially planar, comprises four symmetrically disposed sections 26,28,30,32 each of generally truncated triangular shape defined between associated extents of a pair of diagonals extending between opposed corners of the base portion 22, and a central section 34.

As shown in FIG. 3, the thickness of the sections 26 to 32 tapers from the outer regions thereof towards the section 34, the precise configuration being chosen such that, on stretch/blow moulding thereof, a container 2 of the desired shape results. The sections 26 to 34 respectively of the preform 20 comprise the walls 6 to 12 and the transverse base of the final container, the junctions between adjacent walls, and between each wall and the base, of the final container 2 being generally rounded, and the walls 6 to 12 of the container 2 tapering gradually from the neck 4 of the container towards the base thereof.

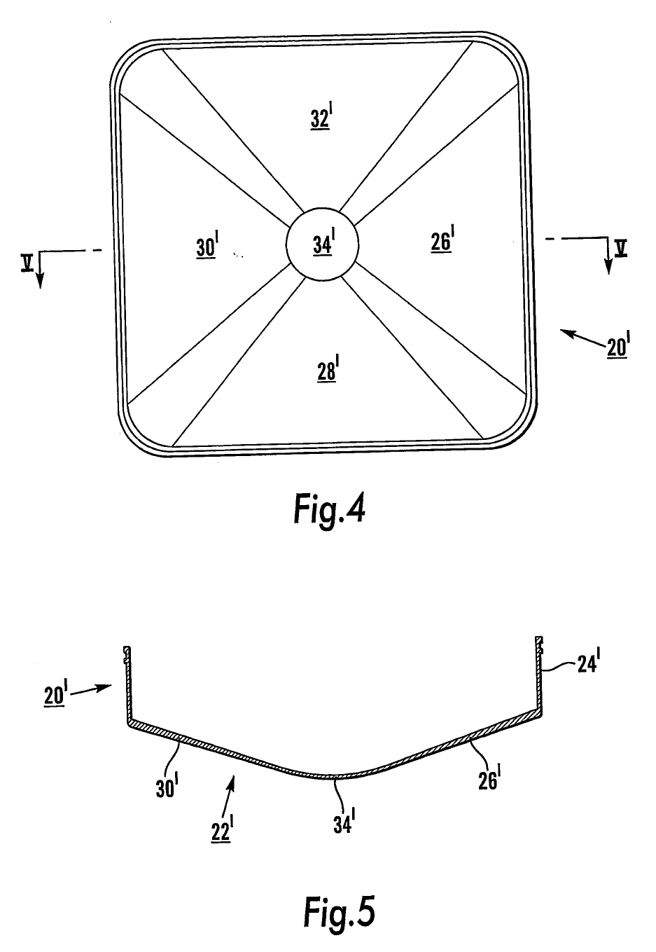

Referring to FIGS. 4 and 5, there is shown an alternative preform according to the invention in which components equivalent to those of the preform of FIGS. 2 and 3 are similarly referenced but with a dash added thereto.

Again the preform 20′ is injection moulded from PET, and includes a square neck portion 24′. Integrally formed with the neck portion 24′ is a base portion 22′ of generally square truncated pyramidical form. More particularly, the base portion includes four symmetrically disposed sections 26′,28′,30′,32′, each of generally truncated triangular shape. Each section 26′,28′,30′,32′, lies in a plane making a shallow angle with that containing the lower ends of the walls defining the neck portion 24′, the thickness of the sections 26′,28′,30′,32′ each tapering from the outer region thereof towards the centre of the base portion 22′.

The inner regions of the sections 26′,28′,30′,32′, merge into a generally circular central section 34′ of the base portion 22′, while the junctions between adjacent sections 26′,28′,30′,32′ are generally rounded as indicated at 50′ in FIG. 3.

On stretch/blow moulding, of the preform 20′ shown in FIGS. 3 and 4 there is formed a container similar to that shown in FIG. 1 but the base of which includes a central region defined by the section 34′ of the preform. In this embodiment, the sections 26′,28′,30′ and 32′ each form walls of the container equivalent to the wall 6,8,10 and 12 respectively of the container 2 of FIG. 1, together with respective portions of the base of the resultant container.

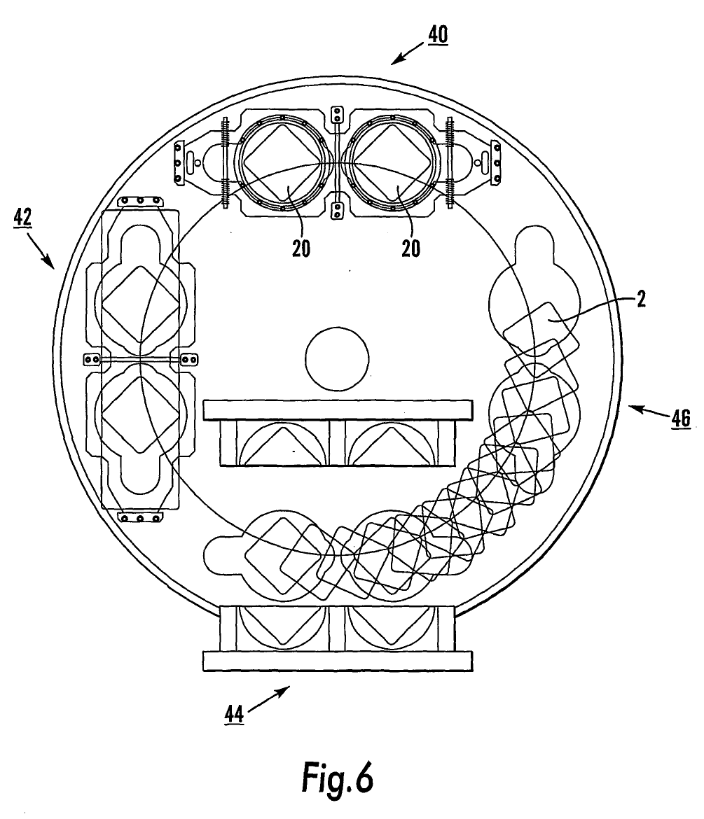

FIG. 6 is a plan view of a machine for manufacturing a container from the preforms of either FIGS. 2 and 3 or FIGS. 4 and 5.

The machine effectively incorporates four stations at a first 40 of which two injection moulded performs are produced, at a second 42 of which, rotatably displaced by 90° from the first station 40, the preforms are conditioned, at a third 44 of which, rotatably displaced by 90° from the second station 42, the conditioned preforms are stretched and blown, and at a fourth 46 of which, rotatably displaced by 90° from the third station 44, the completed containers are ejected.

Clearly other forms of machine could be used, while the resultant container may be provided with a lid and with tamper evident elements reacting between the lid and the container.

Other modifications and variations from the described and illustrated arrangements will be apparent to those skilled in the art.

1. A preform (20) for a plastics container (2) having a substantially rectangular body portion with a substantially rectangular neck (4) thereto, the preform (20) being characterised by four upstanding sidewalls defining a substantially rectangular neck portion (24) thereto, and a base portion (22) of substantially rectangular transverse section, the base portion (22) comprising four sections (26,28,30,32) each extending from the lower end of an associated sidewall and tapering in both width and thickness toward the centre of the base portion (22), one section (26,28,30,32) to form each wall (6,8,10,12) of the container (2), the base portion (22) further comprising a central section (34) into which the tapering sections (26,28,30,32) merge, said central section to form part at least of the base of the resilient container (2).

2. A preform as claimed in claim 1 in which the base portion (22) thereof is substantially planar.

3. A preform as claimed in claim 1 or claim 2 in which the central section (34) of the base portion (22) is substantially rectangular, and, on stretch/blow moulding of the preform (20), comprises the base of the resultant container (2).

4. A preform as claimed in claim 1 in which the base portion (22′) is of generally truncated pyramidical shape, the central section (34′) of the base portion (22′) being substantially circular, and, on stretch/blow moulding of the preform (20′), comprises the central regions of the base of the resultant container.

5. A preform as claimed in any one of claims 1 to 4 the material of which is polyethylene terephthalate (PET).

6. A preform as claimed in claim 5 and injection moulded from PET.

7. A plastics container formed by stretch/blow moulding a preform (20) as claimed in any one of claims 1 to 6, the container (2) comprising a substantially rectangular neck (4) defined by the neck portion (24) of the preform (20), four walls (6,8,10,12) each defined by one of the tapered sections (26,28,30,32) of the preform (20), and a base including the central section (34) of the preform.

8. A method of manufacturing a plastics container (2) comprising the steps of providing a preform (20) as claimed in any one of claims 1 to 6, and stretch/blow moulding the preform (20) into a substantially rectangular container (2).

9. A machine for manufacturing a plastics container comprising a first station (40) for forming preforms (20) as claimed in any one of claims 1 to 6, a second station (42) for conditioning the preforms (20), a third station (44) for blowing and stretching the preforms (20) into substantially rectangular container (2), and a fourth station (46) from which the containers (2) are ejected.
